(19) United States
(12) Patent Application Publication
(10) Pub. No.: US 2018/0005120 A1
(43) Pub. Date: Jan. 4, 2018

(54) DATA MINING INTEREST GENERATOR

(71) Applicant: Futurewei Technologies, Inc., Plano, TX (US)

(72) Inventor: Jiangsheng Yu, San Jose, CA (US)

(21) Appl. No.: 15/199,576

(22) Filed: Jun. 30, 2016

(51) Int. Cl. G06N 5/02; G06F 17/30

(52) U.S. Cl. CPC G06N 5/025; G06F 17/30994

(57) ABSTRACT

A method includes obtaining, at one or more processors, data comprising multiple variables corresponding to multiple samples in a very large dataset, defining, via the one or more processors, multiple sets of variables occurring in the samples comprising a set of x variables and a set of y variables, where the intersection of the sets is zero, for each set of variables, determining, via the one or more processors, a support for each set and a union of each set, determining, via the one or more processors, an interest for each of the multiple association rules of the sets of variables, and determining, via the one or more processors, a chi squared interest, (χ² interest), for each association to identify related sets of variables, including almost exclusive relationships.

### FIELD OF THE INVENTION

The present disclosure is related to data mining, and in particular to a data mining interest generator for identifying associations in large sets of data.

### BACKGROUND

Association rule mining (ARM) is an important feature in knowledge discovery, as association rules identify relationships between data in large data collections. Knowledge discovery has many successful applications to various domains, such as market analysis, Web information processing, recommendation systems, log analysis, bioinformatics, etc.

Knowledge or data mining focuses on the discovery of unknown properties hidden in large sets of data. With the rise of knowledge discovery in databases (KDD) (an interdisciplinary field of computer science with applications to market basket analysis, Web information processing, recommendation system, log analysis, bioinformatics, etc.), more and more techniques of machine learning and statistics are being applied to ARM, for the purpose of detecting latent relations between objects or concepts.

As a simplified example, in supermarkets it is observed that a customer who buys onions and salad cream is likely to buy potatoes. The fact is briefly denoted by an association rule {onions, salad cream} [symbol] {potatoes}. In KDD, association rule mining evaluates the confidence and interest of a candidate rule, to explore the valuable relations among variables.

### SUMMARY

A method includes obtaining, at one or more processors, data comprising multiple variables corresponding to multiple samples in a very large dataset, defining, via the one or more processors, multiple sets of variables occurring in the samples comprising a set of x variables and a set of y variables, where the intersection of the sets is zero, for each set of variables, determining, via the one or more processors, a support for each set and a union of each set, determining, via the one or more processors, an interest for each of the multiple association rules of the sets of variables, and determining, via the one or more processors, a chi squared interest, (χ² interest), for each association to identify related sets of variables, including almost exclusive relationships.

A computer implemented system includes a non-transitory memory storage comprising instructions and one or more processors in communication with the memory, wherein the one or more processors execute the instructions to obtain, via the one or more processors at a programmed computer, data comprising multiple variables corresponding to multiple samples in a very large dataset, define, via the one or more processors, multiple sets of variables occurring in the samples comprising a set of x variables and a set of y variables, where the intersection of the sets is zero, for each set of variables, determine, via the one or more processors, a support for each set and a union of each set, determine, via the one or more processors, an interest for each of the multiple association rules of the sets of variables, and determine, via the one or more processors, a chi squared interest, (χ² interest), for each association to identify related sets of variables, including almost exclusive relationships.

A non-transitory computer readable media storing computer instructions that when executed by one or more processors, cause the one or more processors to perform the steps of obtaining, via the one or more processors, data comprising multiple variables corresponding to multiple samples in a very large dataset, defining, via the one or more processors, multiple sets of variables occurring in the samples comprising a set of x variables and a set of y variables, where the intersection of the sets is zero, for each set of variables, determining, via the one or more processors, a support for each set and a union of each set, determining, via the one or more processors, an interest for each of the multiple association rules of the sets of variables, and determining, via the one or more processors, a chi squared interest, (χ² interest), for each association to identify related sets of variables, including almost exclusive relationships.

### BRIEF DESCRIPTION OF THE DRAWINGS

FIG. 1 is a block flow diagram of a system to perform association rule mining (ARM) according to an example embodiment.

FIG. 2 is a simple graphic example of a dataset comprising items purchased at a grocery store over a period of time by multiple customers of the store according to an example embodiment.

FIG. 3 is a graph illustrating χ²-interest for two different sample sizes, n, according to an example embodiment.

FIG. 4 is a flowchart illustrating a method of determining chi squared interest, including almost exclusive relationships according to an example embodiment.

FIG. 5 is a graph illustrating the χ²-interest surface, in variables of u, w according to an example embodiment.

FIG. 6 is a graph illustrating that the interest surface is much flatter than the χ²-interest surface, in variables of u, v according to an example embodiment.

FIG. 7 is a Table illustrating χ²-interest on an invertebrate paleontology knowledgebase (IPKB) according to an example embodiment.

FIG. 8 a table illustrating that a feature value y=“visceral” with antecedents extracted and measured by χ²-interest are semantically related according to an example embodiment.

FIG. 9 is a table related to a data set of Groceries which happens to come from a real-world point-of-sale transactions in 30 days according to an example embodiment.

FIG. 10 is a table illustrating 2-term antecedents of y={whole milk} extracted from the public database of Groceries, associated with χ²-interest and interest values according to an example embodiment.

FIG. 11 illustrates a network formed by all the extracted 2-term antecedents of y₁={whole milk}; y₂={bottled water, yogurt} and y₃={rolls/buns, yogurt} according to an example embodiment.

FIG. 12 is a block diagram illustrating circuitry for implementing algorithms and performing methods according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

Current forms of association rule mining (ARM) utilize programmed computers to evaluate a confidence and interest of a candidate rule, to explore the valuable relations among variables in very large datasets having many thousands if not millions of entries. Associations may be hidden in such large sets of data and are imperceptible to humans. Candidate rules for a data set may be obtained in many different ways, and may involve single items or sets of items. One example way to develop candidate rules is to simply perform a brute force analysis of the data, sorting the items in the data by frequency of occurrence or even alphabetically, and creating a candidate rule for each pair of items. For instance, using the simplified example referenced in the background, if the items correspond to items purchased in a grocery store, candidate rules may start utilizing a sorted list that starts with apples and artichokes. In other words, when someone purchases apples, how often do they also other items in the list: artichokes, or bananas, or cherries, etc. Further candidates may also be explored that involves sets of items. If someone buys apples and cinnamon, are they also likely to buy butter or flour, or butter and flour, or a prepared pie crust?

While uses of ARM are described with respect to simplified sets of data to facilitate understanding of the inventive subject matter, it should be recognized that many different types of data sets may be analyzed that may have many different associations that are generally not perceptible by humans. Some associations may be almost exclusive, generally meaning that if someone buys one product, they hardly ever buy another product. Prior methods of analyzing proposed association rules have not been able to discern such almost exclusive relationships.

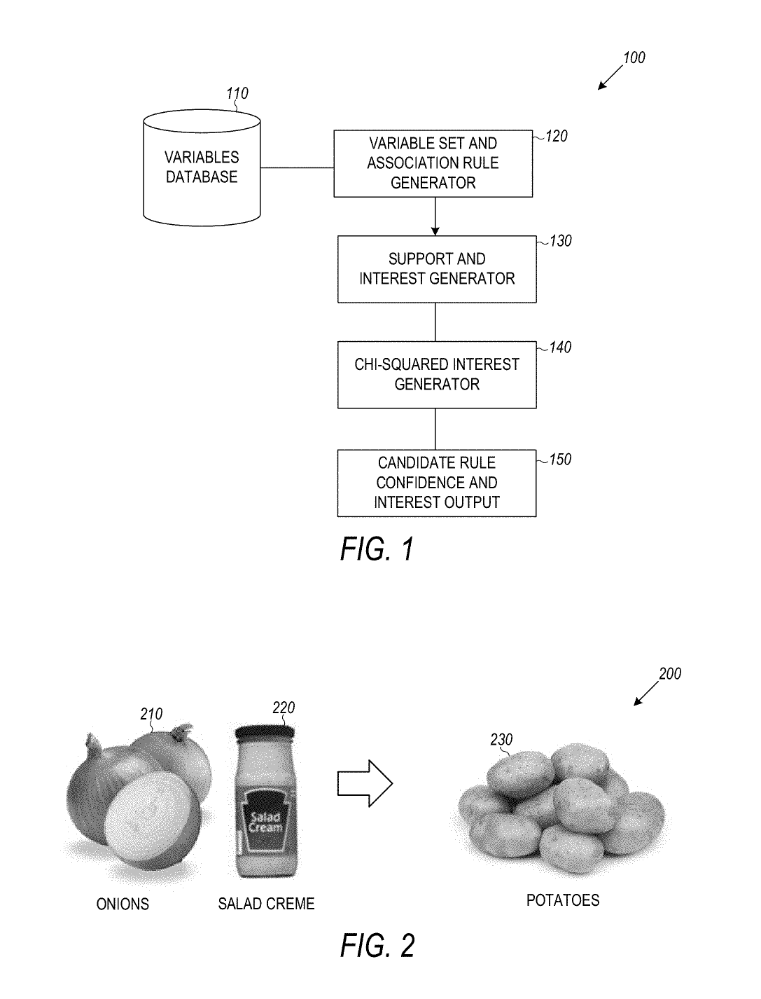

FIG. 1 is a block flow diagram of a system 100 to perform ARM. A database of variables is illustrated at 110 and may be comprised of any type of data, such as a paleontology knowledgebase, a data related to sets of events, or a dataset of grocery transactions for example. At 120, system 100 derives variable sets and generates association rule candidates from the variable sets. Each variable set may include one or more items from the database 110. At 130, a measure of support and interest is generated for each variable set and the association rule candidates. The measures of support and interest are then used by a Chi-Squared (χ²) interest generator 140 to generate a measure of (χ²) interest for each candidate. A candidate rule confidence and interest output may be provided at 150 in the form of text, tables, and graphs illustrating interest between the sets of variables. Confidence corresponds to the confidence of the measure of support.

FIG. 2 is a simple graphic example 200 of a dataset comprising items purchased at a grocery store over a period of time by multiple customers of the store. One variable set includes onions 210 and salad creme 220. Another variable set includes potatoes 230. Example 200 illustrates a candidate rule of {onions; salad creme}=>potatoes, or given the purchase of onions and salad creme, what is the likelihood that potatoes will also be purchased in a same transaction? There are many uses one can make of the results, such as creating displays of items that are related near each other, creating advertising for one set at a low price and charging a higher price for a highly likely other set, providing reminders to customers to help customers who forgot to purchase the other item, or even providing coupons for items that are likely to be purchased by the customer to engender loyalty. These are simple examples to facilitate understanding of the inventive subject matter. In more complex examples many other benefits of improved data mining may be obtained, including the above mentioned almost exclusive relationships.

In further detail, once candidate rules have been generated at 120, ARM may be used to evaluate the confidence and interest of each candidate rule. For example, let x be a set of variables, its support is usually defined as the proportion of observing x in the whole data. That is, supp(x)=Nₓ/n, where Nₓ is the number of observations of x in a sample with size n.

The support for each set of variables may then be used to obtain the confidence and interest of each candidate rule. For clarity, x∪y is denoted by x [symbol] y, if x∩y=0. In other words, x [symbol] y, is the union of x and y if neither x nor y contain common variables. For any association rule of x [symbol] y, meaning if x occurs, is y also likely to occur, where x, y are two sets of variables satisfying x∩y=0, its confidence conf(x [symbol] y)=supp(x [symbol] y) supp(x) is actually the estimate of conditional probability P(y|x). The conditional probability is the probability of y given x.

A conventional measure of interest (or lift) of a rule x [symbol] y is defined by

$$interest ( x ⇒ y ) = \frac{supp ( x ⊎ y )}{supp ( x ) \cdot supp ( y )} \qquad ( 1 )$$

The rules with large interest are usually desirable in practice. Since (1) is simple in computation, it is widely used in ARM. However, sometimes (1) lacks rationality.

In an extreme case, supp(x [symbol] y)=supp(x)=supp(y)=k/n, where k is the number of observations in a sample n, so that the prior measure of interest(x [symbol] y)=k/n/((k/n)*(k/n))=n/k. It means that the relationship between x and y is determinate in the observations. For convenience, such x, y are called binded.

Using the prior measure of interest (1), it is hard to give a rational interpretation to the binded phenomenon that interest(x [symbol] y)=n/k decreases when k increases.

In various embodiments of the present subject matter, a new measure of interestingness, referred to as chi squared interest (χ² interest) is induced from a likelihood ratio, and may be interpreted by a Kullback-Leibler divergence, which is a measure of the difference between two two-point distributions. A distinguishing feature of the new measure of interestingness is its bias to the high-frequency association rules, which are those association rules that occur or are observed very often in a dataset. At the same time, it is capable of finding out the “almost exclusive” relationships between objects, which prior measures failed to provide. An almost exclusive relationship refers to a very low association between two sets of variables. In other words, observations will rarely include both sets of variables.

In one embodiment, it is assumed that the number of observing x and y in all samples (e.g., sale transactions, or sentences in a corpus) is binomially distributed, denoted by Nx [symbol] y˜B(n, θ), where θ is an unknown probability parameter of observing x [symbol] y in a sample.

When [symbol] is the total number of observing [symbol] in a sample, the following is the likelihood function of parameter θ.

L(θ\ [symbol] = [symbol] )= [symbol] (1−θ) [symbol] (2)

The likelihood function (2) is usually denoted by L(θ) for simplicity. Equation (2) is a unimodal function of θ and the maximum likelihood estimate (MLE) of θ is

$$\hat{θ} = \frac{{N}_{x ⊎ y}}{n}$$

If x, y are independent, then 0 can also be estimated by p=NxN_{y}/n², and the likelihood ratio L, L(\hat{θ})L(p)>1, is close to 1. Otherwise, this ratio should be much bigger than 1.

When n is sufficiently large,

χ²=2[ln L(\hat{θ}/ [symbol] )−ln L(p| [symbol] )]˜χ²(1) (3)

The random variable χ² varies in [0,+∞). In detail, χ² is constructed by the random variables [symbol] , Nₓ and N_{y} as follows.

$${x}^{2} = 2 {N}_{x ⊎ y} ln \frac{{nN}_{x ⊎ y}}{{N}_{x} {N}_{y}} + 2 ( n - {N}_{x ⊎ y} ) \\ ln \frac{1 - {N}_{x ⊎ y} / n}{1 - {N}_{x} {N}_{y} / {n}^{2}} ∼ {x}^{2} ( 1 ) \qquad ( 4 )$$

The variable defined by equation (4) is a χ²-interest, whose value measures the objective belief about the association rule x [symbol] y. In Neyman-Pearson hypothesis testing theories, at the given significance level α, the critical region of rejecting the null hypothesis H₀ that x, y are independent is R=[χ_{α}²(1),+∞), where χ_{α}²(1) is the α-quantile of χ²(1) distribution. For example, χ_{0.01}²(1)≈6.635. Thus, a value of chi-squared interest greater than approximately 6.635 is considered a high value. Values at about this level and higher signify higher and higher reliability of corresponding association rules.

It means that, there is likely an association rule between x and y, if the observations of [symbol] = [symbol] , Nₓ=nₓ and N_{y}=n_{y} make the value of equation (4) lie in the critical region R. And, the bigger χ²-value, the more probable that x, y are not independent.

The χ²-interest of a rule x [symbol] y is defined by:

$${χ}^{2} = 2 n \cdot supp ( x ⊎ y ) ln interest ( x ⇒ y ) + 2 n \cdot \overline{supp} ( x ⊎ y ) ln \overline{interest} ( x ⇒ y ) , \\ where \overline{supp (} x ⊎ y ) = 1 - supp ( x ⊎ y ) = 1 - {N}_{x ⊎ y} / n , and \\ \overline{interest} ( x ⇒ y ) = \frac{1 - {N}_{x ⊎ y} / n}{1 - {N}_{x} {N}_{y} / {n}^{2}} \qquad ( 5 )$$

Apparently, s̅u̅p̅p̅(x [symbol] y) measures the degree that the data do not support x [symbol] y. And i̅n̅t̅e̅r̅e̅s̅t̅(x [symbol] y) measures the ratio of s̅u̅p̅p̅(x [symbol] y) to that expected if x, y are independent.

When (x, y) are binded, i.e., [symbol] =nₓ=n_{y}=k, where k=1, 2, . . . , n. By (4), the χ²-interest value is thus:

$${χ}^{2} = 2 k ln \frac{n}{k} + 2 ( n - k ) ln \frac{n}{n + k} \qquad ( 6 )$$

For any fixed

$$n , {f}_{n} ( t ) = 2 t ln \frac{n}{t} + 2 ( n - t ) ln \frac{n}{n + t}$$

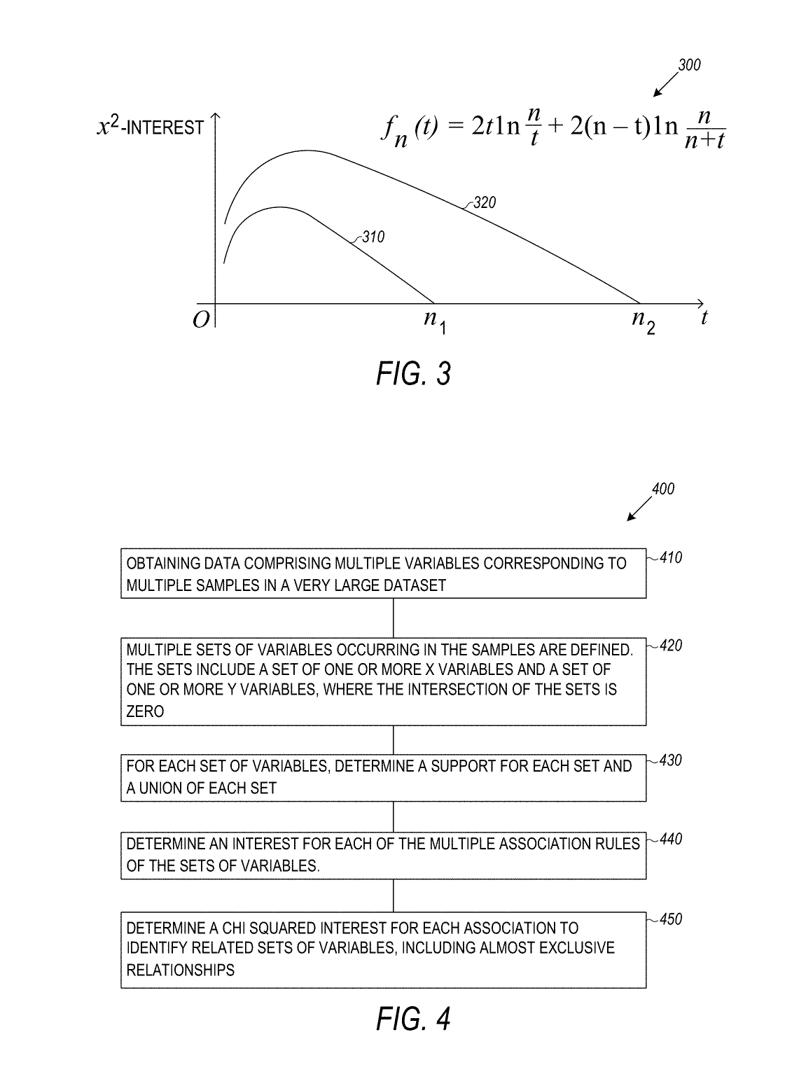

is a unimodal function of t, illustrated in FIG. 3 at 300. Without loss of generality, let t=tₙ be the maximum point of fₙ(t). The χ²-interest increases when k varies from 1 to └tₙ┘, and then decreases to 0 when k approaches to n. Line 310 corresponds to n₁, which is less than n₂ corresponding to line 320. Both lines have the same general shape. Especially, when k=n, (x, y) is observed in all samples and definitely is of no interest to ARM.

FIG. 4 is a flowchart illustrating a method 400 of determining chi squared interest, including almost exclusive relationships. Method 400 includes obtaining data comprising multiple variables corresponding to multiple samples in a very large dataset at 410. A very large dataset includes a dataset having many thousands of samples, such as transactions or objects with variables describing the transactions or objects. At 420, multiple sets of variables occurring in the samples are defined. The sets include a set of one or more x variables and a set of one or more y variables, where the intersection of the sets is zero.

For each set of variables at 430, method 400 determines a support for each set and a union of each set, and at 440, an interest for each of the multiple association rules of the sets of variables. At 450, a chi squared interest is determined for each association to identify related sets of variables, including almost exclusive relationships.

One virtue of χ²-interest is that this concept comes from the frequentist statistics, with a well specified distribution in applications. As long as the sample size is sufficient large, the χ²-interest of x [symbol] y makes sense, in the aspect of measuring the degree of non-independency between x and y. The discussed example of binded rules shows that χ²-interest coincides with intuition regarding the interest measurement as illustrated in graph form in FIG. 1 at 100. A unimodal function fₙ(t) is called the binded χ²-interest function, where tε[1, n]. If n1<n2, fₙ₁₍ₜ₎ is shown at 110 and fₙ₂₍ₜ₎ is shown at 120. It is seen that fₙ₁₍ₜ₎<fₙ₂₍ₜ₎.

Let u=supp(x [symbol] y) and v=supp(x)·supp(y), then interest(x [symbol] y)=u/v and the χ²-interest is

$${χ}^{2} = 2 nu ln \frac{u}{v} + 2 n ( 1 - u ) ln \frac{1 - u}{1 - v} \qquad ( 7 )$$

In fact, equation (6) can be further interpreted by means of Kullback-Leibler divergence, a similarity between two distinct distributions.

χ²=2nD_{KL}(U∥V) (8)

where U˜u [symbol] 1 [symbol] +(1−u) [symbol] 0 [symbol] (two-point distribution), V˜v [symbol] 1 [symbol] +(1−v) [symbol] 0 [symbol] , and D_{KL}(U∥V) is the Kullback-Leibler divergence between U and V. If u is close to v, then the value of equation (7) is close to 0.

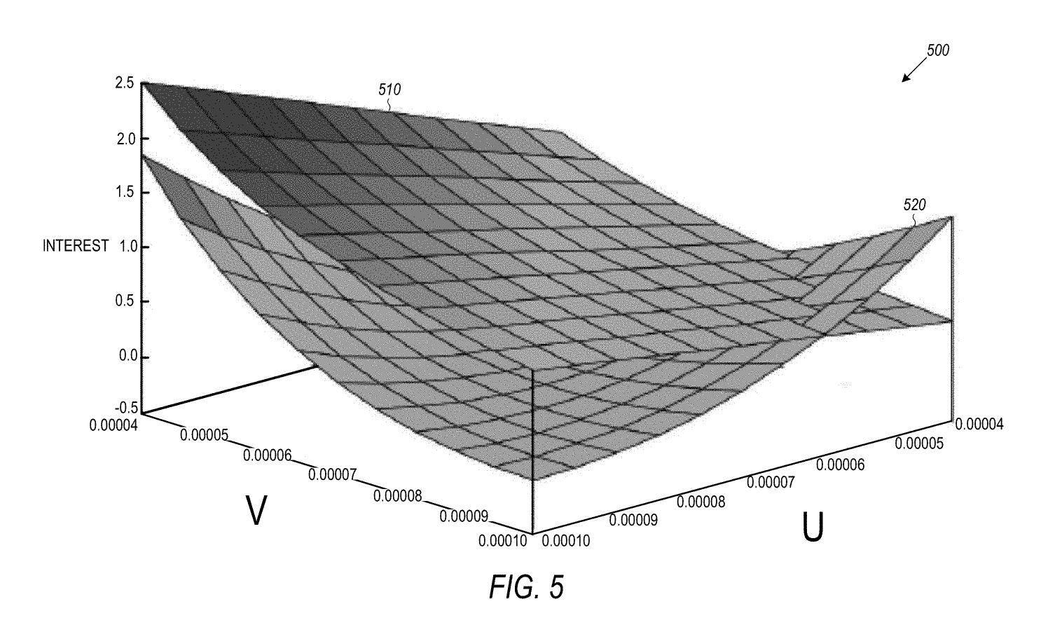

FIG. 5 is a graph 500 showing a χ²-interest surface and a conventional interest surface for comparing differences between the interest surfaces. Note that the conventional interest surface 510 is much flatter than the χ²-interest surface 520, in variables of u, v. Interest is represented by the vertical axis in the graph, with the x and y axis corresponding to different measures of support as described below. For any fixed u, as v→0, χ²-interest approaches to +∞ faster than the traditional interest. The interest surface 510, which is flatter, and the χ²-interest surface 520 in variables of u=supp(x [symbol] y) and v=supp(x)·supp(y) are from a sample size of n=29051. The χ²-interest surface is able to provide information that allows identification of almost exclusive relationships. Such almost exclusive relationships are not discernable from the conventional interest surface 510.

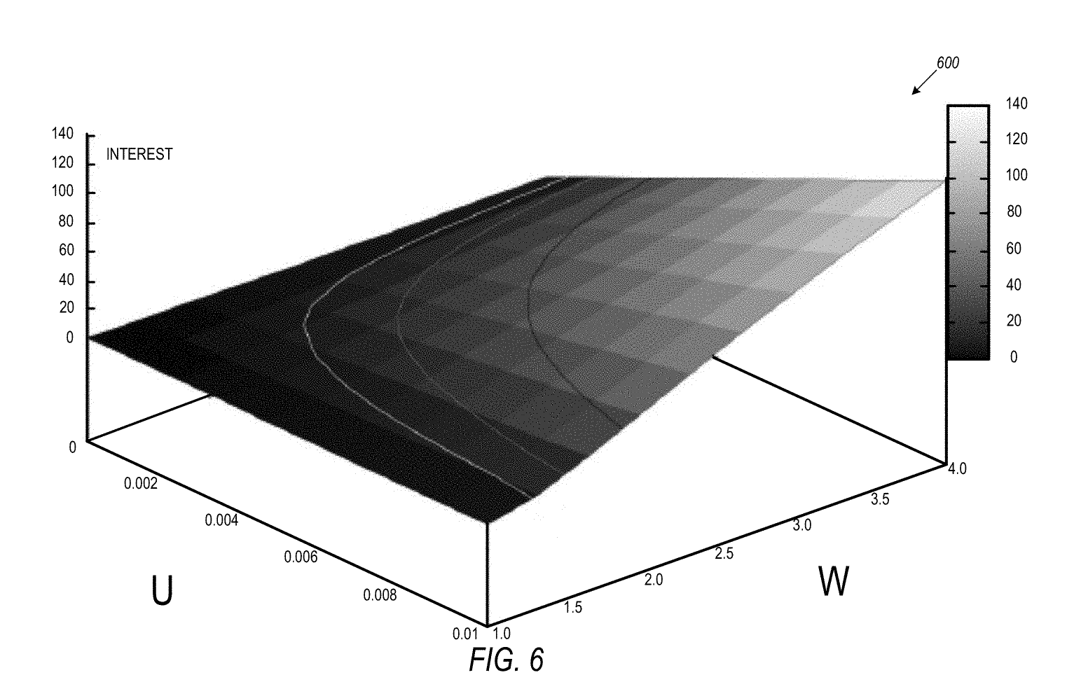

FIG. 6 illustrates the χ²-interest surface 600 in variables of u=supp(x [symbol] y) and w=interest(x [symbol] y), where the sample size is n=9835. The sample size in FIG. 6 is much less than the sample size in FIG. 5, yet the χ²-interest surface still provides information that allows identification of almost exclusive relationships.

FIGS. 5 and 6 illustrate that the χ²-interest surfaces are symmetric with respect to u=v. Similarly, let u=supp(x [symbol] y) and w=interest(x [symbol] y), then

$${χ}^{2} = 2 nu ln w + 2 n ( 1 - u ) ln \frac{1 - u}{1 - u / w} \qquad ( 9 )$$

For any fixed u (or w), (8) is a monotonic function of w (or u). The χ²-interest surface in u, w is illustrated by FIG. 6. The property of the contour of the χ²-interest surface indicates a simple but interesting fact that for any fixed χ²-interest, the more supp(x [symbol] y), the less interest(x [symbol] y), and vice versa.

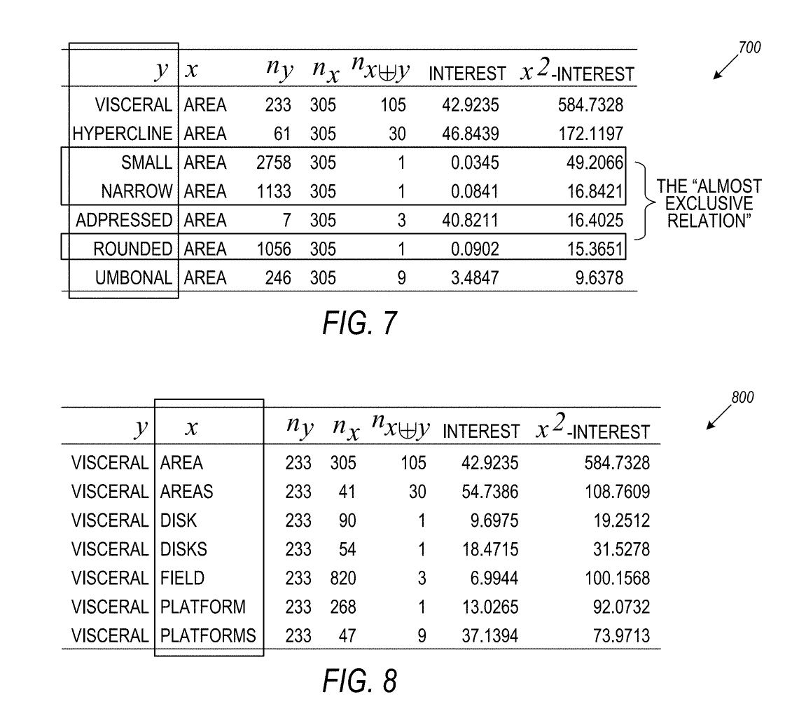

FIG. 7 is a Table 700 illustrating χ²-interest on an invertebrate paleontology knowledgebase (IPKB), available at http://ipkbase.ittc.ku.edu. Consider the pattern of “adjective+noun” in sentences, the association rule x [symbol] y can be interpreted as “feature [symbol] value”. For instance, Table 700 shows all possible feature values of “area” in the corpus of brachiopods in IPKB. It is found that the χ²-interest is biased to the high-frequency observations. The values of x=“area” are extracted by restricting χ²-interest>χ²_{0.01}. The rules satisfying conf(x [symbol] y)>0:05 are then picked out.

Another interesting knowledge mined by χ²-interest is the “almost exclusive” relationship between objects of concern. For instance, in Table 700, “small” is a significant “almost exclusive” feature value of “area” in IPKB. These kinds of facts are usually ignored by the traditional ARM.

A Table 800 in FIG. 8 illustrates a feature value y=“visceral” where the antecedents extracted and measured by χ²-interest are semantically related. As an inverse problem of extracting feature values, all possible features of a given feature value can be extracted and measured by χ²-interest in a similar way. For instance, the features with value “visceral” are semantically related in the corpus of IPKB.

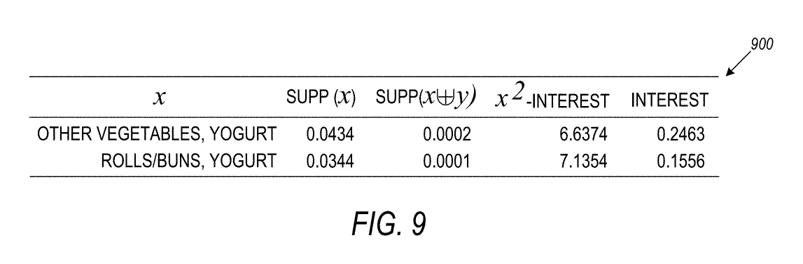

FIG. 9 is a Table 900 related to a data set of Groceries which happens to come from a real-world point-of-sale transactions in 30 days, which totally contains n=9835 transactions in 169 items. The “almost exclusive” relation can also be detected in the dataset of Groceries in table 900. For example, the value of χ²-interest ensures that x={rolls/buns; yogurt} is non-independent of y={white wine}. The association relationship between x and y is significant. However,

That is, the confidence of x [symbol] y is too small. It means that, in general, the customer who buys {rolls/buns; yogurt} does not buy {white wine}. Moreover, there is no antecedent of {rolls/buns; yogurt} that contains the variable of {white wine}. Thus, the combination of χ²-interest and confidence can be used to detect almost exclusive relationships.

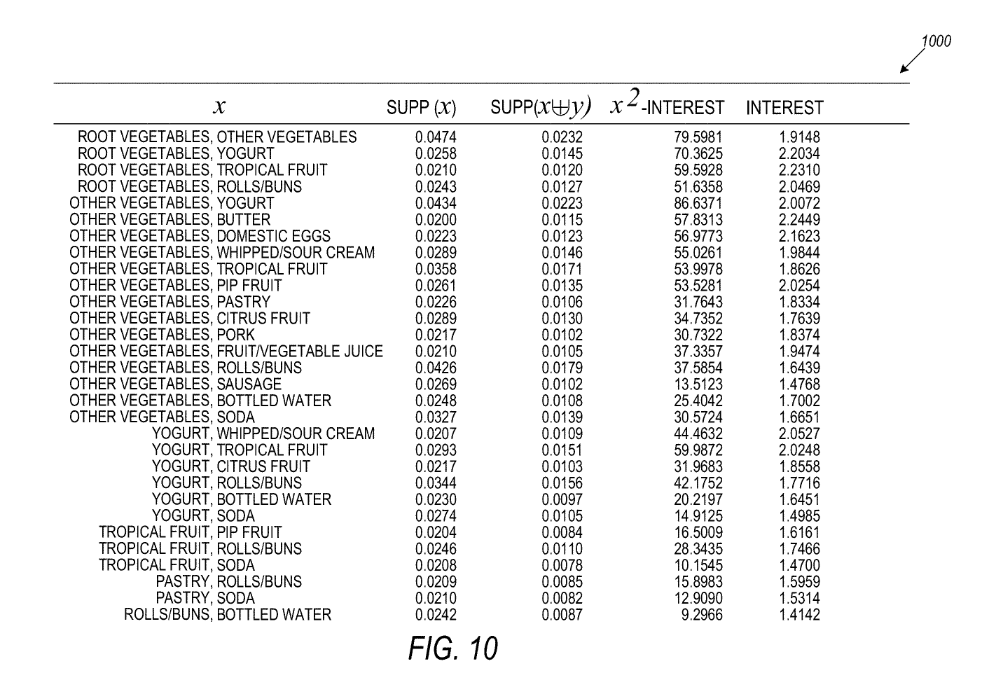

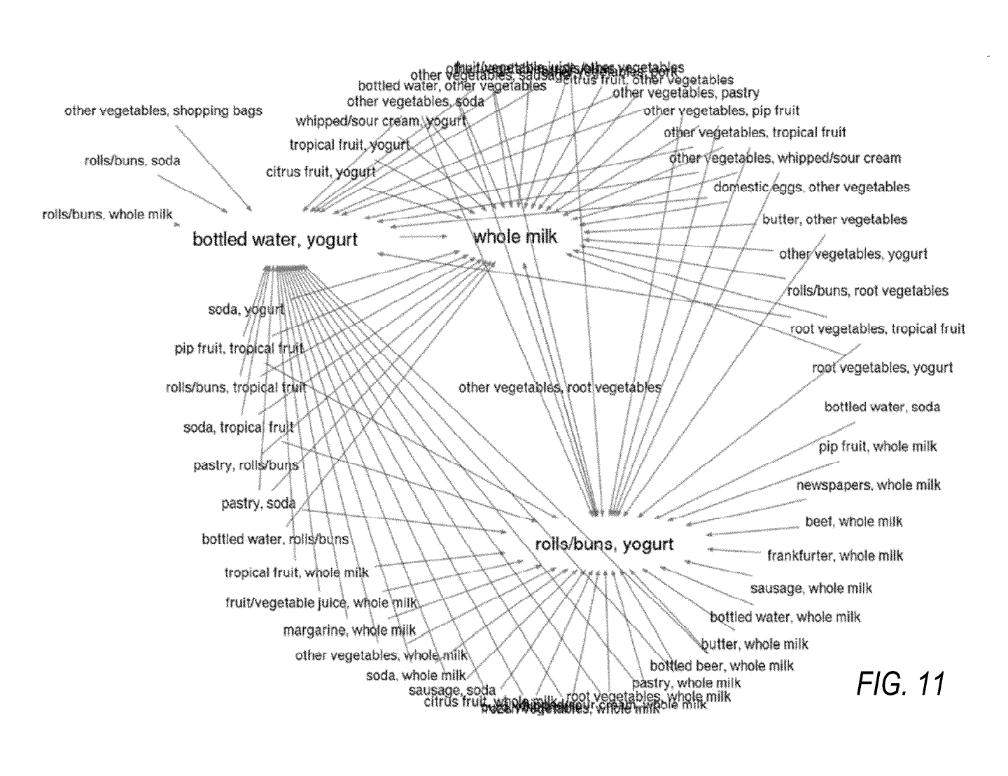

Some 2-term antecedents of y={whole milk} extracted from the public database of Groceries, associated with χ²-interest and interest values, are listed as shown in table 1000 in FIG. 10. The χ²-interests and interests of 2-term x and y={whole milk}. The Spearman's rank correlation coefficient between the interest and χ²-interest values is about 0.8914. Using χ²-interest, the k-term antecedents of any concerned items could be extracted from the grocery data. For example, FIG. 11 at 1100 shows a network formed by all the extracted 2-term antecedents of y₁={whole milk}; y₂={bottled water, yogurt} and y₃={rolls/buns, yogurt}. Each item is coupled by a line to other items, where the length of the line is proportional to the χ²-interest between the items, which in one embodiment end up somewhat circular in shape. It is easy to find the evidence in table 1100 that the transition rule does not always hold for associations. For instance, {rolls/buns, soda} [symbol] {bottled water, yogurt} [symbol] {whole milk}. However, {rolls/buns, soda} [symbol] {whole milk}.

Based on likelihood ratio, the use of χ²-interest provides a well-defined measurement of interestingness for the association rule x [symbol] y, which evaluates the degree of non-independency between x and y. If the sample size is sufficiently large, the χ²-interest is χ²(1) distributed, and can be further interpreted by a Kullback-Leibler divergence.

The properties and advantages of χ²-interest include a bias to high-frequency observations, relationship to interest, etc. The χ²-interest is capable of mining the rules indicating the “almost exclusive” relation.

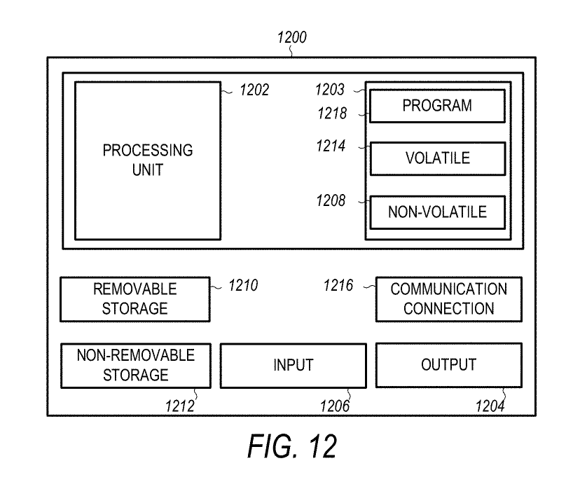

FIG. 12 is a block diagram illustrating circuitry for implementing algorithms and performing methods according to example embodiments. The data sets may be stored on a database system, including an in memory database in some embodiments, as well as data warehouse systems. All components need not be used in various embodiments. For example, the clients, servers, and cloud based resources may each use a different set of components, or in the case of servers for example, larger storage devices.

One example computing device in the form of a computer 1200 may include a processing unit 1202, memory 1203, removable storage 1210, and non-removable storage 1212. Although the example computing device is illustrated and described as computer 1200, the computing device may be in different forms in different embodiments. For example, the computing device may instead be a smartphone, a tablet, smartwatch, or other computing device including the same or similar elements as illustrated and described with regard to FIG. 12. Further, although the various data storage elements are illustrated as part of the computer 1200, the storage may also or alternatively include cloud-based storage accessible via a network, such as the Internet or server based storage.

Memory 1203 may include volatile memory 1214 and/or non-volatile memory 1208. Computer 1200 may include—or have access to a computing environment that includes—a variety of computer-readable media, such as volatile memory 1214 and/or non-volatile memory 1208, removable storage 1210, and/or non-removable storage 1212. Computer storage includes random access memory (RAM), read only memory (ROM), erasable programmable read-only memory (EPROM), electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 1200 may include or have access to a computing environment that includes input 1206, output 1204, and a communication connection 1216. Output 1204 may include a display device, such as a touchscreen, that also may serve as an input device. The input 1206 may include one or more of a touchscreen, touchpad, mouse, keyboard, camera, one or more device-specific buttons, one or more sensors integrated within or coupled via wired or wireless data connections to the computer 1200, and other input devices. The computer may operate in a networked environment using the communication connection 1216 to connect to one or more remote computers, such as database servers. The remote computer may include a personal computer (PC), server, router, network PC, a peer device or other common network node, or the like. The communication connection 1216 may include a Local Area Network (LAN), a Wide Area Network (WAN), cellular, WiFi, Bluetooth, or other networks.

Computer-readable instructions stored on a computer-readable medium are executable by the processing unit 1202 of the computer 1200. A program 1218 comprises computer-readable instructions for interest data-mining, as discussed in any of the embodiments herein.

### Examples

1. In example 1, a method includes obtaining, at one or more processors, data comprising multiple variables corresponding to multiple samples in a very large dataset, defining, via the one or more processors, multiple sets of variables occurring in the samples comprising a set of x variables and a set of y variables, where the intersection of the sets is zero, for each set of variables, determining, via the one or more processors, a support for each set and a union of each set, determining, via the one or more processors, an interest for each of the multiple association rules of the sets of variables, and determining, via the one or more processors, a chi squared interest, (χ² interest), for each association to identify related sets of variables, including almost exclusive relationships.

2. The method of example 1 wherein x∪y is denoted by x [symbol] y, if x∩y=0 and wherein the chi-squared interest is stored in a memory in association with each variable.

3. The method of example 2 wherein support for x is defined as supp(x)=Nx/n, where Nx is the number of observations of x in a sample with size n.

4. The method of example 3 wherein support for y is defined as supp(y)=Ny/n, where Ny is the number of observations of y in a sample with size n.

5. The method of example 4 wherein for any association rule of x [symbol] y, its confidence conf(x [symbol] y)=supp(x [symbol] y)/supp(x).

6. The method of example 5 wherein the χ²-interest of a rule x [symbol] y is defined by:

$${χ}^{2} = 2 n \cdot supp ( x ⊎ y ) ln interest ( x ⇒ y ) + 2 n \cdot \overline{supp} ( x ⊎ y ) ln \overline{interest} ( x ⇒ y ) , \\ where \overline{supp} ( x ⊎ y ) = 1 - supp ( x ⊎ y ) = 1 - {N}_{x ⊎ y} / n , and$$

$$\overline{interest} ( x ⇒ y ) = \frac{1 - {N}_{x ⊎ y} / n}{1 - {N}_{x} {N}_{y} / {n}^{2}} .$$

7. The method of example 5 and further wherein a combination of high χ²-interest with a low confidence is representative of an almost exclusive relationship.

8. The method of example 7 wherein conf(x [symbol] y)>0:05 is indicative of a positive association between x and y where the χ²-interest is high.

9. The method of any of examples 1-8 and further comprising generating a graphical output having lines drawn between associations of each set of variables, wherein the sets of variable are generally arranged in a circle with the length of the lines connecting the sets of variables being proportional to the χ²-interest between the sets of variables.

10. In example 10, a computer implemented system includes a non-transitory memory storage comprising instructions and one or more processors in communication with the memory, wherein the one or more processors execute the instructions to obtain, via the one or more processors, data comprising multiple variables corresponding to multiple samples in a very large dataset, define, via the one or more processors, multiple sets of variables occurring in the samples comprising a set of x variables and a set of y variables, where the intersection of the sets is zero, for each set of variables, determine, via the one or more processors, a support for each set and a union of each set, determine, via the one or more processors, an interest for each of the multiple association rules of the sets of variables, and determine, via the one or more processors, a chi squared interest, (χ² interest), for each association to identify related sets of variables, including almost exclusive relationships.

11. The system of example 10 wherein x∪y is denoted by x [symbol] y, if x∩y=0, support for x is defined as supp(x)=Nx/n, where Nx is the number of observations of x in a sample with size n, and support for y is defined as supp(y)=Ny/n, where Ny is the number of observations of y in a sample with size n.

12. The system of example 11 wherein for any association rule of x [symbol] y, its confidence conf(x [symbol] y)=supp(x [symbol] y)/supp(x).

13. The system of example 12 wherein the χ²-interest of a rule x [symbol] y is defined by:

$${χ}^{2} = 2 n \cdot supp ( x ⊎ y ) ln interest ( x ⇒ y ) + 2 n \cdot \overline{supp} ( x ⊎ y ) ln \overline{interest} ( x ⇒ y ) , \\ where \overline{supp} ( x ⊎ y ) = 1 - supp ( x ⊎ y ) = 1 - {N}_{x ⊎ y} / n , and$$

$$\overline{interest} ( x ⇒ y ) = \frac{1 - {N}_{x ⊎ y} / n}{1 - {N}_{x} {N}_{y} / {n}^{2}} .$$

14. The system of example 13 wherein a combination of high χ²-interest with a low confidence is representative of an almost exclusive relationship and wherein conf(x [symbol] y)>0:05 is indicative of a positive association between x and y where the χ²-interest is high.

15. The system of any of examples 10-14 and further comprising a display device coupled to the processor, and wherein the operations further comprise generating a graphical output for display on the display device having lines drawn between associations of each set of variables, wherein the sets of variable are generally arranged in a circle with the length of the lines connecting the sets of variables being proportional to the χ²-interest between the sets of variables.

16. In example 16, a non-transitory computer readable media storing computer instructions that when executed by one or more processors, cause the one or more processors to perform the steps of obtaining, via the one or more processors, data comprising multiple variables corresponding to multiple samples in a very large dataset, defining, via the one or more processors, multiple sets of variables occurring in the samples comprising a set of x variables and a set of y variables, where the intersection of the sets is zero, for each set of variables, determining, via the one or more processors, a support for each set and a union of each set, determining, via the one or more processors, an interest for each of the multiple association rules of the sets of variables, and determining, via the one or more processors, a chi squared interest, (χ² interest), for each association to identify related sets of variables, including almost exclusive relationships.

17. The non-transitory computer readable storage media of example 16 wherein x∪y is denoted by x [symbol] y, if x∩y=0, support for x is defined as supp(x)=Nx/n, where Nx is the number of observations of x in a sample with size n, support for y is defined as supp(y)=Ny/n, where Ny is the number of observations of y in a sample with size n, and wherein for any association rule of x [symbol] y, its confidence conf(x [symbol] y)=supp(x [symbol] y)/supp(x).

18. The non-transitory computer readable storage media of example 17 wherein the χ²-interest of a rule x [symbol] y is defined by:

$${χ}^{2} = 2 n \cdot supp ( x ⊎ y ) ln interest ( x ⇒ y ) + 2 n \cdot \overline{supp} ( x ⊎ y ) ln \overline{interest} ( x ⇒ y ) , \\ where \overline{supp} ( x ⊎ y ) = 1 - supp ( x ⊎ y ) = 1 - {N}_{x ⊎ y} / n , and$$

$$\overline{interest} ( x ⇒ y ) = \frac{1 - {N}_{x ⊎ y} / n}{1 - {N}_{x} {N}_{y} / {n}^{2}} .$$

19. The non-transitory computer readable storage media of example 18 wherein a combination of high χ²-interest with a low confidence is representative of an almost exclusive relationship and wherein conf(x [symbol] y)>0:05 is indicative of a positive association between x and y where the χ²-interest is high.

20. The non-transitory computer readable storage media of any of examples 16-19 wherein the operations further comprise generating a graphical output for a display device having lines drawn between associations of each set of variables, wherein the sets of variable are generally arranged in a circle with the length of the lines connecting the sets of variables being proportional to the χ²-interest between the sets of variables.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims

What is claimed is:

1. A method comprising:
obtaining, at one or more processors, data comprising multiple variables corresponding to multiple samples in a very large dataset;
defining, via the one or more processors, multiple sets of variables occurring in the samples comprising a set of x variables and a set of y variables, where the intersection of the sets is zero;
for each set of variables, determining, via the one or more processors, a support for each set and a union of each set;
determining, via the one or more processors, an interest for each of the multiple association rules of the sets of variables; and
determining, via the one or more processors, a chi squared interest, (χ² interest), for each association to identify related sets of variables, including almost exclusive relationships.

2. The method of claim 1 wherein x∪y is denoted by x [symbol] y, if x∩y=0 and wherein the chi-squared interest is stored in a memory in association with each variable.

3. The method of claim 2 wherein support for x is defined as supp(x)=Nₓ/n, where Nₓ is the number of observations of x in a sample with size n.

4. The method of claim 3 wherein support for y is defined as supp(y)=N_{y}/n, where N_{y} is the number of observations of y in a sample with size n.

5. The method of claim 4 wherein for any association rule of x [symbol] y, its confidence conf(x [symbol] y)=supp(x [symbol] y)/supp(x).

6. The method of claim 5 wherein the χ²-interest of a rule x [symbol] y is defined by:
$${χ}^{2} = 2 n \cdot supp ( x ⊎ y ) ln interest ( x ⇒ y ) + 2 n \cdot \overline{supp} ( x ⊎ y ) ln \overline{interest} ( x ⇒ y ) , \\ where \overline{supp} ( x ⊎ y ) = 1 - supp ( x ⊎ y ) = 1 - {N}_{x ⊎ y} / n , and$$
$$\overline{interest} ( x ⇒ y ) = \frac{1 - {N}_{x ⊎ y} / n}{1 - {N}_{x} {N}_{y} / {n}^{2}} .$$

7. The method of claim 5 wherein a combination of high χ²-interest with a low confidence is representative of an almost exclusive relationship.

8. The method of claim 7 wherein conf(x [symbol] y)>0:05 is indicative of a positive association between x and y where the χ²-interest is high.

9. The method of claim 1 and further comprising generating a graphical output having lines drawn between associations of each set of variables, wherein the sets of variable are generally arranged in a circle with the length of the lines connecting the sets of variables being proportional to the χ²-interest between the sets of variables.

10. A computer implemented system comprising:
a non-transitory memory storage comprising instructions; and
one or more processors in communication with the memory, wherein the one or more processors execute the instructions to:
obtain, via the one or more processors, data comprising multiple variables corresponding to multiple samples in a very large dataset;
define, via the one or more processors, multiple sets of variables occurring in the samples comprising a set of x variables and a set of y variables, where the intersection of the sets is zero;
for each set of variables, determine, via the one or more processors, a support for each set and a union of each set;
determine, via the one or more processors, an interest for each of the multiple association rules of the sets of variables; and
determine, via the one or more processors, a chi squared interest, (χ² interest), for each association to identify related sets of variables, including almost exclusive relationships.

11. The system of claim 10 wherein x∪y is denoted by x [symbol] y, if x∩y=0, support for x is defined as supp(x)=Nₓ/n, where Nₓ is the number of observations of x in a sample with size n, and support for y is defined as supp(y)=N_{y}/n, where N_{y} is the number of observations of y in a sample with size n.

12. The system of claim 11 wherein for any association rule of x [symbol] y, its confidence conf(x [symbol] y)=supp(x [symbol] y)/supp(x).

13. The system of claim 12 wherein the χ²-interest of a rule x [symbol] y is defined by:
$${χ}^{2} = 2 n \cdot supp ( x ⊎ y ) ln interest ( x ⇒ y ) + 2 n \cdot \overline{supp} ( x ⊎ y ) ln \overline{interest} ( x ⇒ y ) , \\ where \overline{supp} ( x ⊎ y ) = 1 - supp ( x ⊎ y ) = 1 - {N}_{x ⊎ y} / n , and$$
$$\overline{interest} ( x ⇒ y ) = \frac{1 - {N}_{x ⊎ y} / n}{1 - {N}_{x} {N}_{y} / {n}^{2}} .$$

14. The system of claim 13 wherein a combination of high χ²-interest with a low confidence is representative of an almost exclusive relationship and wherein conf(x [symbol] y)>0:05 is indicative of a positive association between x and y where the χ²-interest is high.

15. The system of claim 10 further comprising a display device coupled to the processor, wherein the operations further comprise generating a graphical output for display on the display device having lines drawn between associations of each set of variables, wherein the sets of variable are generally arranged in a circle with the length of the lines connecting the sets of variables being proportional to the χ²-interest between the sets of variables.

16. A non-transitory computer readable media storing computer instructions that when executed by one or more processors, cause the one or more processors to perform the steps of:
obtaining, via the one or more processors, data comprising multiple variables corresponding to multiple samples in a very large dataset;
defining, via the one or more processors, multiple sets of variables occurring in the samples comprising a set of x variables and a set of y variables, where the intersection of the sets is zero;
for each set of variables, determining, via the one or more processors, a support for each set and a union of each set;
determining, via the one or more processors, an interest for each of the multiple association rules of the sets of variables; and
determining, via the one or more processors, a chi squared interest, (χ² interest), for each association to identify related sets of variables, including almost exclusive relationships.

17. The non-transitory computer readable storage media of claim 16 wherein x∪y is denoted by x [symbol] y, if x∩y=0, support for x is defined as supp(x)=Nₓ/n, where Nₓ is the number of observations of x in a sample with size n, support for y is defined as supp(y)=N_{y}/n, where N_{y} is the number of observations of y in a sample with size n, and wherein for any association rule of x [symbol] y, its confidence conf(x [symbol] y)=supp(x [symbol] y)/supp(x).

18. The non-transitory computer readable storage media of claim 17 wherein the χ²-interest of a rule x [symbol] y is defined by:
$${χ}^{2} = 2 n \cdot supp ( x ⊎ y ) ln interest ( x ⇒ y ) + 2 n \cdot \overline{supp} ( x ⊎ y ) ln \overline{interest} ( x ⇒ y ) , \\ where \overline{supp} ( x ⊎ y ) = 1 - supp ( x ⊎ y ) = 1 - {N}_{x ⊎ y} / n , and$$
$$\overline{interest} ( x ⇒ y ) = \frac{1 - {N}_{x ⊎ y} / n}{1 - {N}_{x} {N}_{y} / {n}^{2}} .$$

19. The non-transitory computer readable storage media of claim 18 wherein a combination of high χ²-interest with a low confidence is representative of an almost exclusive relationship and wherein conf(x [symbol] y)>0:05 is indicative of a positive association between x and y where the χ²-interest is high.

20. The non-transitory computer readable storage media of claim 16 wherein the operations further comprise generating a graphical output for a display device having lines drawn between associations of each set of variables, wherein the sets of variable are generally arranged in a circle with the length of the lines connecting the sets of variables being proportional to the χ²-interest between the sets of variables.
